(19) United States
(12) Patent Application Publication
(10) Pub. No.: US 2025/0151954 A1
(43) Pub. Date: May 15, 2025

(54) Gas Grill

(71) Applicant: Ningbo Huige Outdoor Products Co., Ltd., Ningbo (CN)

(72) Inventor: Songcun Zheng, Ningbo (CN)

(21) Appl. No.: 19/026,929

(22) Filed: Jan. 17, 2025

(30) Foreign Application Priority Data
Jun. 11, 2024 (CN) 202410743400.5

(51) Int. Cl. A47J 37/07

(52) U.S. Cl. CPC A47J 37/0713

(57) ABSTRACT

A gas grill comprises a grill body and a stand which is arranged below the grill body and supports the grill body, wherein a mounting chamber is arranged in the stand, and a gas oven is arranged in the mounting chamber. The gas grill has a simple structure; the gas oven is mounted in the mounting chamber formed in the stand below the grill body, such that the overall space is fully and reasonably used; the functions of the grill are expanded and diversified.

### TECHNICAL FIELD

The invention relates to a grill, in particular to a gas grill.

### DESCRIPTION OF RELATED ART

With the growth of the social economy and the gradual improvement of living and consumption standards, the pursuit of the diet of people is becoming increasingly higher. Barbecuing, as a form of cooking, is extremely popular. Barbecue grills, as common equipment for barbecuing, are purchased by many families for outdoor dining at ordinary times. Existing barbecue grills adopt different fuels according to their different structures, and common fuels adopted by the barbecue grills include wood, coal, gas, etc. Barbecue grills using gas as the fuel are generally referred to as gas grills. A major advantage of the gas grills is that the roasting temperature is more stable and controllable. However, existing gas grills can only function for barbecuing.

### BRIEF SUMMARY OF THE INVENTION

The technical issue to be settled by the invention is to provide a gas grill, which has a simple structure and multiple functions.

The technical solution adopted by the invention to settle the above technical issue is as follows:

A gas grill comprises a grill body and a stand which is arranged below the grill body and supports the grill body, wherein a mounting chamber is arranged in the stand, and a gas oven is arranged in the mounting chamber.

A support base plate is arranged in the stand, the mounting chamber is formed between the support base plate and a bottom of the grill body, and the gas oven is arranged on the support base plate and located below the grill body. The space in the stand is reasonably used, and the gas oven is stably supported by and mounted on the stand by means of the support base plate.

A grill chamber is arranged in the grill body, a gas grill burner is arranged in the grill chamber, and a plurality of bottom through-grooves for connecting the grill chamber and an outside are formed in a bottom of the grill chamber;
the gas oven is arranged below the grill chamber and comprises a cabinet in which a barbecue chamber is formed, the cabinet has a top opening and a front opening which are connected to the barbecue chamber, a top plate is slidably arranged at the top opening, a cabinet door is openably arranged at the front opening, and part of the bottom through-grooves are correspondingly arranged above the top opening;
when slid inwards, the top plate seals the top opening; when slid outwards, the top plate opens the top opening, and the grill chamber is connected to the barbecue chamber by means of the bottom through-grooves arranged above the top opening. The structure is simple, and the functions are further expanded. When the cabinet door is closed and the top plate is slid inwards, the oven functions as an integral and independent unit, and the oven and the grill body perform their own functions and can be used separately. When the top plate is slid outwards, the top opening is opened, the oven will not work separately, and food roasted by the grill body can be placed in the oven; in this case, the grill body is connected to the barbecue chamber by means of the corresponding bottom through-grooves, and heat, generated when the grill body works, enters the barbecue chamber by means of the corresponding bottom through-grooves to maintain the temperature of the food, such that effective utilization of the heat is realized. Moreover, after being slid out, the top plate may be used as a table board where articles can be placed.

The top plate is made from a high-temperature material. When the top plate is slid inwards to seal the top opening, the oven can be effectively protected against a high temperature.

Two sides of the top plate are connected to the cabinet by means of sliding rail mechanisms respectively. The structure is simple, connection is stable, and similar mechanisms applied to drawers in the prior art may be directly used as the sliding rail mechanisms to facilitate assembly and disassembly.

A partition is arranged in the grill body and divides the bottom of the grill chamber into an air inlet area and a heat conduction area, the bottom through-grooves are formed in the air inlet area and the heat conduction area respectively, and the heat conduction area is located right above the top opening. In this way, heat generated in the grill body can be fully used to the maximum extent, and heat losses can be effectively avoided. The bottom through-grooves located in the heat conduction area are mainly used for conducting heat from the grill body into the oven, and the bottom through-grooves located in the air inlet area are mainly used for guiding air to enter the grill body from the outside.

A gas oven burner is arranged in the gas oven.

A gas control portion is arranged in front of the grill body, and a first knob used for controlling the gas grill burner and a second knob used for controlling the gas oven burner are arranged on the gas control portion. The structure is regular, and operation is easy.

An upper surface of the top plate caves downwards to form a recess. When the top plate seals the top opening, the first recess functions as an oil receiving cavity to facilitate cleaning. When the top plate is used as a table board, the first recess ensures that articles can be stably placed on the table board.

Lateral through-grooves are formed in lateral portions of the grill body. Air enters the grill body from the outside by means of the lateral through-grooves.

Compared with the prior art, the invention has the following advantages: the structure is simple; the gas oven is mounted in the mounting chamber formed in the stand below the grill body, such that the overall space is fully and reasonably used; the functions of the grill are expanded and diversified.

### BRIEF DESCRIPTION OF THE SEVERAL VIEWS OF THE DRAWINGS

FIG. 1 is a stereogram according to the invention;

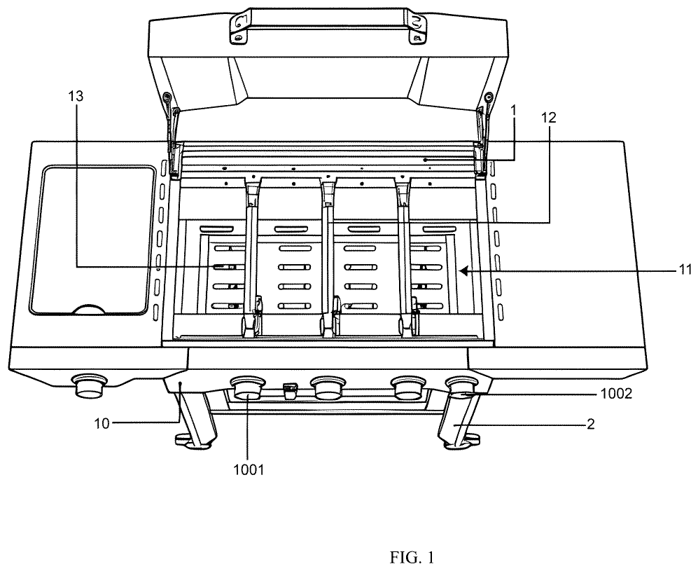

FIG. 2 is a sectional view according to the invention;

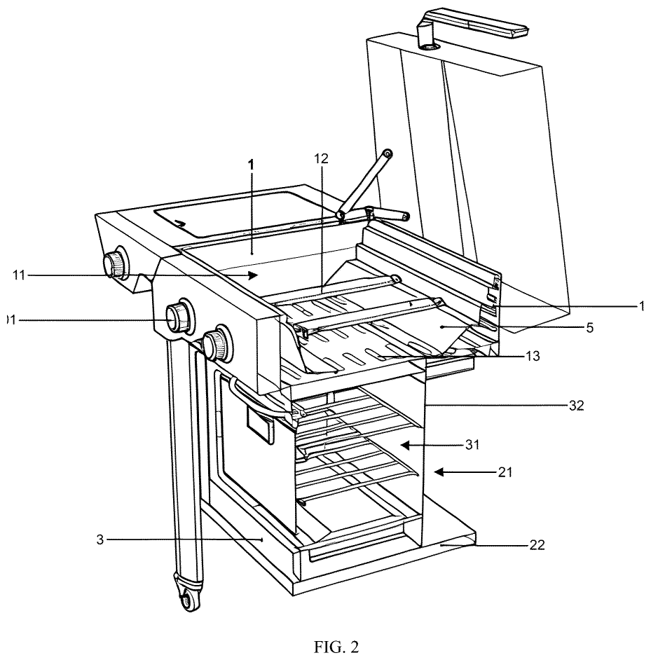

FIG. 3 is a sectional view in a state where a top plate is slid out according to the invention;

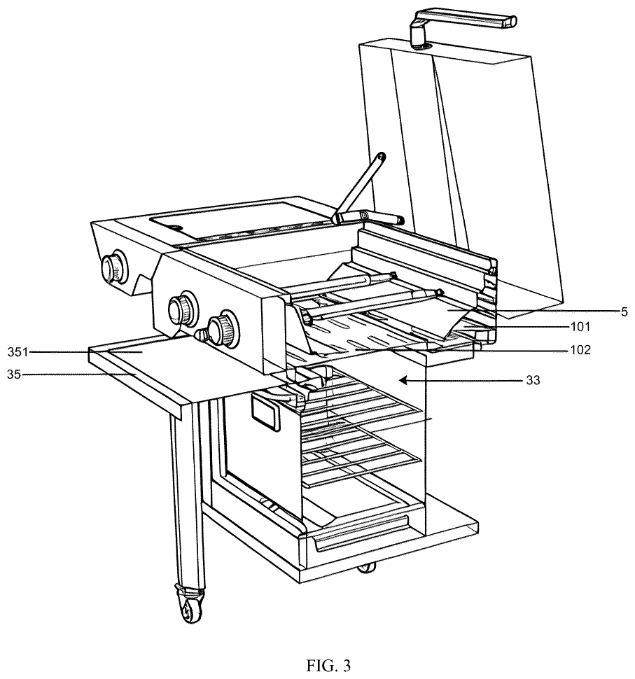

FIG. 4 is a stereogram in a state where the top plate seals a top opening and a cabinet door is opened according to the invention.

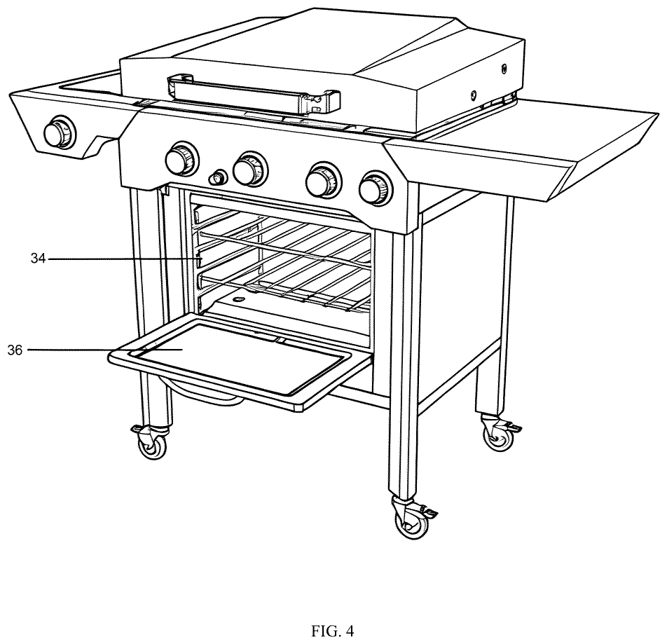

### DETAILED DESCRIPTION OF THE INVENTION

The invention is described in further detail below in conjunction with accompanying drawings and embodiments.

As shown, a gas grill comprises a grill body 1 and a stand 2, which is arranged below the grill body 1 and supports the grill body 1, wherein a mounting chamber 21 is arranged in the stand 2, and a gas oven 3 is arranged in the mounting chamber 21.

In this specific embodiment, a support base plate 22 is arranged in the stand 2, the mounting chamber 21 is formed between the support base plate 22 and the bottom of the grill body 1, and the gas oven 3 is arranged on the support base plate 22 and located below the grill body 1. The space in the stand 2 is reasonably used, and the gas oven 2 is stably supported by and mounted on the stand 2 by means of the support base plate 22.

In this specific embodiment, a grill chamber 11 is arranged in the grill body 1, gas grill burners 12 are arranged in the grill chamber 11, and a plurality of bottom through-grooves 13 used for connecting the grill chamber 11 and the outside are formed in the bottom of the grill chamber 11.

In this specific embodiment, the gas oven 3 is arranged below the grill chamber 11 and comprises a cabinet 32 in which a barbecue chamber 31 is formed, the cabinet 32 has a top opening 33 and a front opening 34 which are connected to the barbecue chamber 31, a top plate 35 is slidably arranged at the top opening 33, a cabinet door 36 is openably arranged at the front opening 34, and part of the bottom through-grooves 13 are correspondingly arranged above the top opening 33.

When slid inwards, the top plate 35 seals the top opening 33. When slid outwards, the top plate 35 opens the top opening 33, and the grill chamber 11 is connected to the barbecue chamber 31 by means of the bottom through-grooves 13 arranged above the top opening 33. The structure is simple, and the functions are further expanded. When the cabinet door 36 is closed and the top plate 35 is slid inwards, the oven functions as an integral and independent unit, and the oven and the grill body 1 perform their own functions and can be used separately. When the top plate 35 is slid outwards, the top opening 33 is opened, the oven will not work separately, and food roasted by the grill body 1 can be placed in the oven; in this case, the grill body 1 is connected to the barbecue chamber 31 by means of the corresponding bottom through-grooves 13, and heat, generated when the grill body 1 works, enters the barbecue chamber 31 by means of the corresponding bottom through-grooves 13 to maintain the temperature of the food, such that effective utilization of the heat is realized. Moreover, after being slid out, the top plate 35 may be used as a table board where articles can be placed.

In this specific embodiment, the top plate 35 is made from a high-temperature material. When the top plate 35 is slid inwards to seal the top opening 33, the oven can be effectively protected against a high temperature.

In this specific embodiment, two sides of the top plate 35 are connected to the cabinet 32 by means of sliding rail mechanisms (not shown) respectively. The structure is simple, connection is stable, and similar mechanisms applied to drawers in the prior art may be directly used as the sliding rail mechanisms to facilitate assembly and disassembly.

In this specific embodiment, a partition 5 is arranged in the grill body 1 and divides the bottom of the grill chamber 11 into an air inlet area 101 and a heat conduction area 102, the bottom through-grooves 13 are formed in the air inlet area 101 and the heat conduction area 102 respectively, and the heat conduction area 102 is located right above the top opening 33. In this way, heat generated in the grill body 1 can be fully used to the maximum extent, and heat losses can be effectively avoided. The bottom through-grooves 13 located in the heat conduction area 102 are mainly used for conducting heat from the grill body 1 into the oven, and the bottom through-grooves 13 located in the air inlet area 101 are mainly used for guiding air to enter the grill body 1 from the outside.

In this specific embodiment, a gas oven burner (not shown) is arranged in the gas oven 3.

In this specific embodiment, a gas control portion 10 is arranged in front of the grill body 1, and first knobs 1001 used for controlling the gas grill burners 12 and a second knob 1002 used for controlling the gas oven burner are arranged on the gas control portion 10. The structure is regular, and operation is easy.

In this specific embodiment, an upper surface of the top plate 35 caves downwards to form a first recess 351. When the top plate 35 seals the top opening 33, the first recess 351 functions as an oil receiving cavity to facilitate cleaning. When the top plate 35 is used as a table board, the first recess 351 ensures that articles can be stably placed on the table board.

In this specific embodiment, lateral through-grooves 15 are formed in lateral portions of the grill body 1. Air enters the grill body 1 from the outside by means of the lateral through-grooves 15.

What is claimed is:

1. A gas grill, comprising a grill body and a stand, which is arranged below the grill body and supports the grill body, wherein a mounting chamber is arranged in the stand, and a gas oven is arranged in the mounting chamber.

2. The gas grill according to claim 1, wherein a support base plate is arranged in the stand, the mounting chamber is formed between the support base plate and a bottom of the grill body, and the gas oven is arranged on the support base plate and located below the grill body.

3. The gas grill according to claim 1, wherein a grill chamber is arranged in the grill body, a gas grill burner is arranged in the grill chamber, and a plurality of bottom through-grooves for connecting the grill chamber and an outside are formed in a bottom of the grill chamber;
the gas oven is arranged below the grill chamber and comprises a cabinet in which a barbecue chamber is formed, the cabinet has a top opening and a front opening which are connected to the barbecue chamber, a top plate is slidably arranged at the top opening, a cabinet door is openably arranged at the front opening, and part of the bottom through-grooves are correspondingly arranged above the top opening;
when slid inwards, the top plate seals the top opening; when slid outwards, the top plate opens the top opening, and the grill chamber is connected to the barbecue chamber by means of the bottom through-grooves arranged above the top opening.

4. The gas grill according to claim 3, wherein the top plate is made from a high-temperature material.

5. The gas grill according to claim 3, wherein two sides of the top plate are connected to the cabinet by means of sliding rail mechanisms respectively.

6. The gas grill according to claim 3, wherein a partition is arranged in the grill body and divides the bottom of the grill chamber into an air inlet area and a heat conduction area, the bottom through-grooves are formed in the air inlet area and the heat conduction area respectively, and the heat conduction area is located right above the top opening.

7. The gas grill according to claim 3, wherein a gas oven burner is arranged in the gas oven.

8. The gas grill according to claim 7, wherein a gas control portion is arranged in front of the grill body, and a first knob used for controlling the gas grill burner and a second knob used for controlling the gas oven burner are arranged on the gas control portion.

9. The gas grill according to claim 3, wherein an upper surface of the top plate caves downwards to form a recess.

10. The gas grill according to claim 1, wherein lateral through-grooves are formed in lateral portions of the grill body.
